(19) United States
(12) Patent Application Publication
(10) Pub. No.: US 2024/0237018 A1
(43) Pub. Date: Jul. 11, 2024

(54) SYSTEMS AND METHODS FOR UE PROCESSING

(71) Applicant: ZTE CORPORATION, Shenzhen (CN)

(72) Inventors: Shijia SHAO, Shenzhen (CN); Bo GAO, Shenzhen (CN); Shujuan ZHANG, Shenzhen (CN); Ke YAO, Shenzhen (CN); Zhaohua LU, Shenzhen (CN)

(73) Assignee: ZTE CORPORATION, Shenzhen (CN)

(21) Appl. No.: 18/521,833

(22) Filed: Nov. 28, 2023

Related U.S. Application Data
(63) Continuation of application No. PCT/CN2022/070213, filed on Jan. 5, 2023.

(51) Int. Cl. H04W 72/231; H04L 5/00; H04L 27/26

(52) U.S. Cl. CPC H04W 72/231; H04L 5/001; H04L 5/0053; H04L 27/26025

(57) ABSTRACT

Presented are systems and methods for user equipment (UE) processing. A wireless communication device may receive a resource setting indicative of a plurality of sets of channel measurement reference signal (RS) resources (CMRs) from a wireless communication node. The wireless communication device can determine whether a plurality of conditions associated with the plurality of sets of CMRs is satisfied. The wireless communication device can determine whether to report measurement results.

### CROSS-REFERENCE TO RELATED APPLICATION

This application claims the benefit of priority under 35 U.S.C. § 120 as a continuation of PCT Patent Application No. PCT/CN2022/070213, filed on Jan. 5, 2022, the disclosure of which is incorporated herein by reference in its entirety.

### TECHNICAL FIELD

The disclosure relates generally to wireless communications, including but not limited to systems and methods for user equipment (UE) processing.

### BACKGROUND

In the 5th Generation (5G) New Radio (NR) mobile networks, a user equipment (UE) can send data to a base station (BS) by obtaining uplink synchronization and downlink synchronization with the BS. The BS can use a certain type of signaling to configure the UE for uplink and/or downlink transmission, such as downlink control information (DCI).

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may receive a resource setting indicative of a plurality of sets of channel measurement reference signal (RS) resources (CMRs) from a wireless communication node. The wireless communication device can determine whether a plurality of conditions associated with the plurality of sets of CMRs is satisfied. The wireless communication device can determine whether to report measurement results.

In some implementations, a last resource, in each set of the plurality of sets of CMRs, can be associated with a respective condition of the plurality of conditions. In some implementations, the plurality of conditions may consist of three conditions. In some implementations, the plurality of conditions can include at least one of: a first condition that a first distance (Z) between a last symbol of a physical downlink control channel (PDCCH) carrying the DCI signaling, and a first symbol of a physical uplink shared channel (PUSCH) carrying a measurement result, is greater than or equal to a first reference (Z_{ref.}); a second condition that a second distance (Z1′) between a last symbol of a last CSI resource in a first set of the plurality of sets, and the first symbol of the PUSCH, is greater than or equal to a second reference (Z1′_{ref}); or a third condition that a third distance (Z2′) between a last symbol of a last CSI resource in a second set of the plurality of sets, and the first symbol of the PUSCH, is greater than or equal to a third reference (Z2′_{ref}).

In some implementations, the wireless communication device can determine that the plurality of conditions are satisfied. The wireless communication device can determine to report the measurement results corresponding to the plurality of sets of CMRs. In some implementations, the wireless communication device can determine that the first condition is not satisfied. The wireless communication device can determine to ignore the DCI signaling's scheduling of reporting of the one or more measurement results.

In some implementations, the wireless communication device can determine that the first condition is satisfied and at least one of the second condition or the third condition is not satisfied. The wireless communication device can determine, responsive to the first condition being satisfied and at least one of the second condition or the third condition not being satisfied, to: ignore the DCI signaling's scheduling of reporting of the one or more measurement results; or report a measurement result of a set of the plurality of sets of CMRs, corresponding to one of the plurality of conditions that is satisfied. In some implementations, a last resource, in all sets of the plurality of sets of CMRs, can be associated with a condition of the plurality of conditions.

In some implementations, the plurality of conditions consists of two conditions. In some implementations, the plurality of conditions can include at least one of: a first condition that a first distance (Z) between a last symbol of a physical downlink control channel (PDCCH) carrying the DCI signaling, and a first symbol of a physical uplink shared channel (PUSCH) carrying a measurement result, is greater than or equal to a first reference (Z_{ref.}); or a second condition that a second distance (Z′) between a last symbol of a last CSI resource of the plurality of sets, and the first symbol of the PUSCH, is greater than or equal to a second reference (Z′_{ref}).

In some implementations, the wireless communication device can determine that at least one of the first condition or the second condition is not satisfied. The wireless communication device can determine, responsive to at least one of the second condition or the third condition not being satisfied, to ignore the DCI signaling's scheduling of reporting of the one or more measurement results. In some implementations, the first reference, the second reference and/or the third reference can each comprise a respective adjustment added to a respective defined value.

In some implementations, the respective adjustment can be: different between the respective defined values; or same across the respective defined values. In some implementations, the respective adjustment can be: based on a capability of the wireless communication device; different for different subcarrier spacings; or same across the different subcarrier spacings. In some implementations, whether the first reference, the second reference and/or the third reference take on a first set of values or a second set of values, can be indicated by a radio resource control (RRC) parameter or a downlink control information (DCI) signaling.

At least one aspect is directed to a system, method, apparatus, or a computer-readable medium. A wireless communication device can receive a downlink control information (DCI) signaling, which indicates a transmission configuration indicator (TCI) state, from a wireless communication node. The wireless communication device can determine a time for applying the TCI state in one or more component carriers (CCs), according to an offset value relative to a last symbol of an acknowledgment to the DCI signaling.

In some implementations, the offset value is determined from a plurality of offset values each configured via a respective radio resource control (RRC) parameter for a respective group of component carriers (CCs). In some implementations, the offset value is determined from a plurality of offset values each configured via a respective radio resource control (RRC) parameter for a respective list of component carriers (CCs).

In some implementations, the wireless communication device may determine the time for applying the TCI state, using the offset value, a smallest SCS and a reference SCS, where the offset value corresponds to a group or list comprising a first CC. In some cases, the wireless communication device can identify the first CC as a CC with a smallest subcarrier spacing (SCS) amongst the one or more CCs.

In some cases, all CCs in the first group or the first list of CCs may have a same value for the offset value. In some implementations, the offset value is determined from a plurality of offset values can each be configured for a respective component carrier (CC) or bandwidth part (BWP). In some implementations, the wireless communication device can determine the time for applying the TCI state, using the offset value, a smallest SCS and a reference SCS, wherein the offset value corresponds to a first CC.

In some implementations, the wireless communication device can identify the first CC as a CC with a smallest subcarrier spacing (SCS) amongst the one or more CCs. In some implementations, the wireless communication device can receive an indication of the reference SCS from the wireless communication node. In some implementations, CCs may have a same subcarrier spacing (SCS) is configured with a same offset value. In some implementations, the wireless communication device can receive a configuration of a first offset value and a second offset value from a wireless communication node. The wireless communication device can receive the DCI signaling, which indicates to use at least one of: the first offset value or the second offset value from the wireless communication node.

In some implementations, the second offset value comprises an adjustment value. In some implementations, the wireless communication device can determine the time for applying the TCI state, by adding the adjustment value to the first offset value. In some implementations, the adjustment value can be based on a capability of the wireless communication device.

At least one aspect is directed to a system, method, apparatus, or a computer-readable medium. A wireless communication node can send a resource setting indicative of a plurality of sets of channel measurement reference signal (RS) resources (CMRs) to a wireless communication device, causing the wireless communication device to determine whether a plurality of conditions associated with the plurality of sets of CMRs is satisfied; and causing the wireless communication device to determine whether to report measurement results.

At least one aspect is directed to a system, method, apparatus, or a computer-readable medium. A wireless communication node can send a configuration of a plurality of candidate offset values to apply relative to a last symbol of an acknowledgment to a downlink control information (DCI) signaling to a wireless communication device. The wireless communication node can send the DCI signaling, to indicate a transmission configuration indicator (TCI) state to the wireless communication device, causing the wireless communication to determine a time for applying the TCI state.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of channel state information (CSI) in certain systems, in accordance with some embodiments of the present disclosure;

FIG. 4 illustrates an example of CSI reporting for two channel measurement reference (CMR) resource sets, in accordance with some embodiments of the present disclosure;

FIG. 5 illustrates another example of CSI reporting for two CRM resource sets, in accordance with some embodiments of the present disclosure;

FIG. 6 illustrates an example of application time of beam indication, in accordance with some embodiments of the present disclosure;

FIG. 7 illustrates a flow diagram of an example method for CSI reporting, in accordance with an embodiment of the present disclosure; and

FIG. 8 illustrates a flow diagram of an example method for application time of beam indication, in accordance with an embodiment of the present disclosure.

### DETAILED DESCRIPTION

### 1. Mobile Communication Technology and Environment

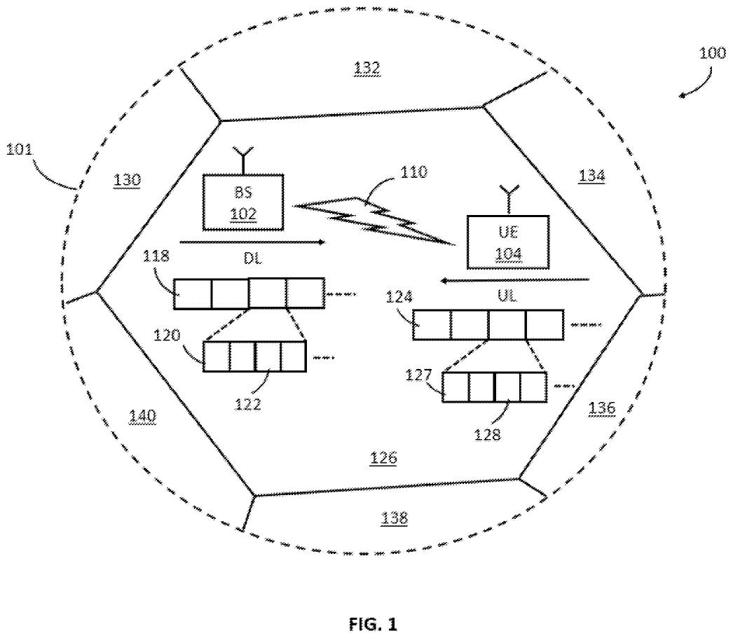

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

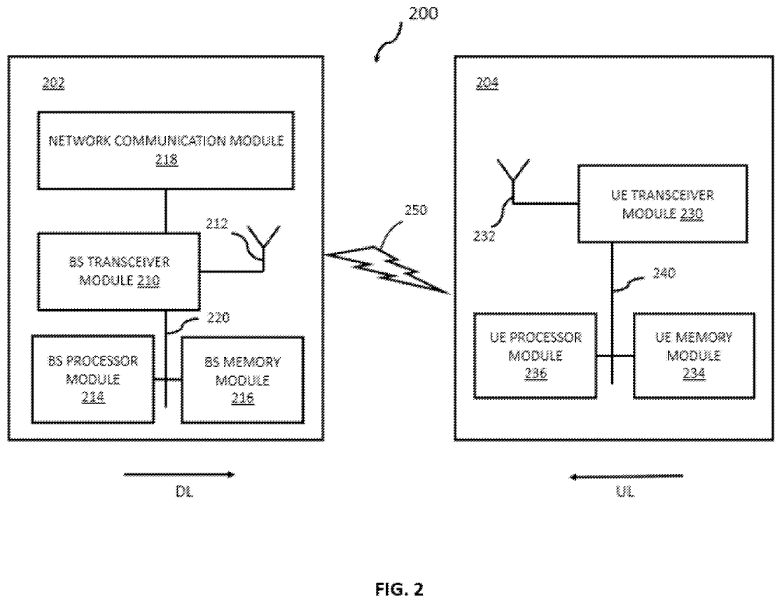

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for UE Processing

In certain systems (e.g., 5G new radio (NR), Next Generation (NG) systems, 3GPP systems, and/or other systems), a multiple transmission and reception point (MTRP) technology can be deployed to improve the coverage at the cell edge and reduce the negative impact of the blocking effect. Gradual standardization of MTRP technology may stabilize the enhancements on downlink transmission. In certain systems, enhancements on the uplink (e.g., communication from UE 104 (e.g., or UE 204) to BS 102 (e.g., or BS 202) may be insufficient. For instance, when the UE 104 has multi-panel transmission capability, channel state information (CSI) report criteria of group-based reporting in beam management may be considered/leveraged/analyzed, such as discussed herein. Further, to unify the uplink and downlink beam indication modes, the unified transmission configuration indicator (TCI) framework may be utilized/implemented. However, in certain systems, the application time of beam indication (e.g., beam application time (BTA) may be unoptimized for the unified TCI framework.

Hence, the systems and methods of the technical solution, discussed herein, can optimize CSI reporting criterion and/or application time of beam indication, thereby improving UE processing time. For example, in MTRP scenario/technology, to enhance the CSI reporting interval criterion, the system may determine a calculation scheme/method/feature of the interval limit based on whether multiple channel measurement reference signal resources (CMRs) are configured in one resource setting. In another example, to enhance the time (e.g., application time) when the UE 104 applies/initiates/configures new beams in the unified TCI states indication scenario, the system may determine/identify/analyze the configuration of different beam application time and the corresponding calculation mode of the UE 104.

In certain systems, a Multi-TRP (Multiple Transmission and Reception Point) approach/feature/technique/technology may utilize/include/leverage multiple TRPs to improve the communication (e.g., transmission and/or reception) throughput in the Long Term Evolution (LTE), Long Term Evolution-Advanced (LTE-A), and/or New Radio (NR) access technology in the Enhanced Mobile Broadband (eMBB) scenario. Further, utilizing the Multi-TRP transmission and/or reception can reduce the probability of information blockage (e.g., reduce packet drop, which would otherwise lead to wasted resources and/or increased traffic, etc.) and improve the transmission reliability in Ultra-reliability and Low Latency Communication (URLLC) scenarios.

In certain systems, the coordinated multiple points transmission/reception may be divided/split/included/separated/allocated into two types, such as based on or according to a mapping relationship between the transmitted signal flow and multi-TRP/panel. For instance, the two types may include at least a coherent joint transmission and non-coherent joint transmission, among others. For coherent joint transmission, each data layer can be mapped to multiple-TRPs/panels through weighted vectors. In some instances, during deployment (e.g., real-world/actual deployment environment), the coherent joint transmission mode may include higher requirements for synchronization between TRPs and the transmission capability of backhaul links.

For non-coherent joint transmission (NCJT) (e.g., NCJT mode), the NCJT mode may be less affected by the one or more factors. Therefore, certain systems may leverage or consider the NCJT mode in coordinated multiple points transmission/reception. For NCJT, the system may map each data flow only to the port corresponding to the TRP/panel with the same channel large-scale parameters (e.g., Quasi Co Location (QCL)). In some cases, the system may map different data flows to different ports with different large-scale parameters. In this case, one or more TRPs may not need to be processed as a virtual array.

In some systems, group-based beam reporting rules in the MTRP scenario may be preliminarily agreed upon, such as by the standards, specifications, or configurations of the BS 102 and/or the UE 104. For MTRP beam management, the system can support a single CSI report which may consist of or include N beams pairs/groups and M (e.g., M>1) beams per pair/group. The system may support, for MTRP beam management, simultaneous reception of different beams within a pair/group (e.g., group of beams). A UE 104 may be configured with one or more CMR resource sets (e.g., two CMR resources sets) per resource setting for group-based beam reporting. However, in certain systems, problems associated with multiple set configurations may not have been resolved/addressed, such as the limitation for the timing of CSI report. Hence, for DCI-based beam indication, the system can configure the application time of the beam indication to be the first slot that is, for instance, at least X ms or Y symbols after the last symbol of the acknowledgment (e.g., HARQ-ACK) of the joint or separate downlink (DL)/uplink (UL) beam indication.

In some implementations, the definition/term/element/feature/indication/mention of “beam” may include, correspond to, or be a part of quasi-co-location (QCL) state, transmission configuration indicator (TCI) state, spatial relation state (e.g., sometimes referred to as spatial relation information state), reference signal (RS), spatial filter, and/or pre-coding. In some cases, the term “Tx beam” may include or correspond to QCL state, TCI state, spatial relation state, DL/UL reference signal (e.g., channel state information reference signal (CSI-RS), synchronization signal block (SSB) (e.g., sometimes referred to as SS/PBCH), demodulation reference signal (DMRS), sounding reference signal (SRS), and/or physical random access channel (PRACH)), Tx spatial filter, and/or Tx precoding.

In some cases, the term “Rx beam” may include or correspond to QCL state, TCI state, spatial relation state, spatial filter, Rx spatial filter, and/or Rx precoding. The term “beam ID” may include or correspond to equivalent to QCL state index, TCI state index, spatial relation state index, reference signal index, spatial filter index, and/or precoding index. In some cases, the spatial filter may be either UE-side or gNB-side one. The spatial filter may sometimes be referred to as spatial-domain filter.

In some implementations, the term “spatial relation information” can include at least one or more reference RSs. The one or more reference RSs may be used to represent “spatial relation” between targeted “RS or channel” and the one or more reference RSs. In some cases, the term “spatial relation” may refer to the same/quasi-co beam(s), same/quasi-co spatial parameter(s), and/or same/quasi-co spatial domain filter(s). In certain cases, the term “spatial relation” may refer to the beam, spatial parameter, and/or spatial domain filter.

In some cases, the term “QCL state” may include or be a part of one or more reference RSs and/or the corresponding QCL type parameters of the one or more reference RSs. The QCL type parameters may include at least one or a combination of: Doppler spread, Doppler shift, delay spread, average delay, average gain, and/or spatial parameter. The spatial parameter may refer to the spatial Rx parameter. In some cases, the term “TCI state” may include or correspond to “QCL state”.

The QCL types can include at least ‘QCL-TypeA,’ ‘QCL-TypeB,’ ‘QCL-TypeC,’ and/or ‘QCL-TypeD.’ The ‘QCL-TypeA’ can include or correspond to doppler shift, doppler spread, average delay, and/or delay spread. The ‘QCL-TypeB’ can include or correspond to doppler shift, and/or doppler spread. The ‘QCL-TypeC’ can include or correspond to doppler shift, and/or average delay. The ‘QCL-TypeD’ can include or correspond to a spatial Rx parameter.

In some cases, the term “UL signal” can include, correspond to, or represent PRACH, PUCCH, PUSCH, UL DMRS, or SRS. The term “DL signal” can correspond to PDCCH, PDSCH, SSB, DL DMRS, or CSI-RS. The group-based reporting may include at least one of “beam group” based reporting and/or “antenna group” based reporting, among others. The term “beam group” may be described as, for instance, different Tx beams within one group can be simultaneously received or transmitted, and/or Tx beams between different groups may not be simultaneously received or transmitted. The term “beam group” may be described from the UE 104 perspective.

In some implementations, the term “BM RS” may refer to or represent beam management reference signal(s), such as CSI-RS, SSB, or SRS. The the term “BM RS group” may correspond to “grouping one or more BM reference signals,” and BM RSs from a group may be associated with the same TRP. The term “TRP index” can correspond to “TRP ID,” which may be used to distinguish/differentiate/separate different TRPs. The term “panel ID” can correspond to UE panel index.

### A. Implementation 1: CSI Report Criteria

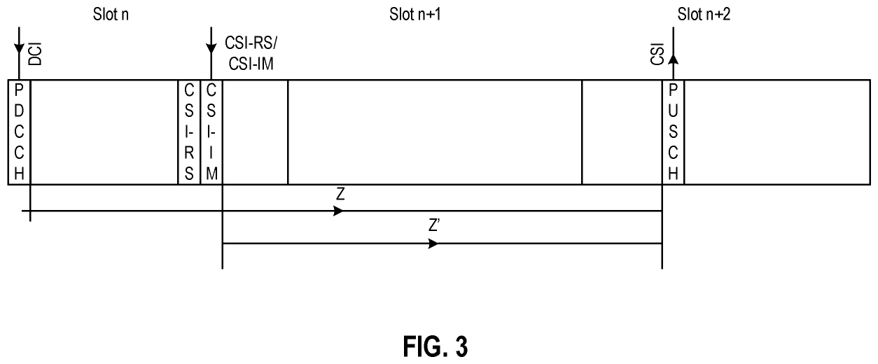

Referring now to FIG. 3, depicted is an example of channel state information (CSI) in certain systems. For example, the BS 102 (e.g., wireless communication node or gNB) can transmit/provide/send a DCI to the UE 104 (e.g., wireless communication device) for triggering/scheduling a CSI reporting. In certain systems, when the CSI request field on a DCI (e.g., sent from the BS 102 to the UE 104) triggers a CSI report(s) on a physical uplink shared channel (PUSCH), the UE 104 can provide/send/transmit a valid CSI report for the n-th triggered report, such as based on one or more conditions/criteria/parameters being met or satisfied. The UE 104 can provide the CSI report in response to at least one or a combination of conditions that are satisfied. The physical downlink control channel (PDCCH) (e.g., on which the DCI is sent to the UE 104), CSI resources, and/or PUSCH, etc. can include various symbols, such as a first symbol to a last symbol, among other symbols in between. For example, the UE 104 can provide the CSI report i) if the first uplink symbol (e.g., a first symbol of the PUSCH) to carry the corresponding CSI report(s) (e.g., measurement result(s)), including the effect of the timing advance, starts no earlier than at symbol Z_{ref} (e.g., sometimes referred to as a first reference), and ii) if the first uplink symbol to carry the n-th CSI report, including the effect of the timing advance, starts no earlier than at symbol Z′_{ref}(n).

In this example, the first condition can include a distance, time, or gap of Z between the last symbol of the PDCCH (e.g., the channel for communicating the DCI from the BS 102 to the UE 104) and the first symbol of PUSCH (e.g., CSI reporting). Hence, the first uplink symbol may start no earlier than at symbol Z_{ref} (e.g., from the distance of Z). Further, in this example, the second condition can include a distance of Z′ between the last symbol of CSI-IM and/or CSI-RS (e.g., CSI resource configured by the DCI) and the first symbol of PUSCH, thereby starting the first uplink symbol no earlier than at symbol Z′_{ref}. The CSI resource can allow the UE 104 to receive the CSI-RS and/or CSI-IM (e.g., for configuring the time domain and/or frequency domain of the UE 104 to receive and perform measurement on the CSI-RS). In response to performing the measurement on the CSI-RS, the UE 104 can determine the channel quality to report to the BS 102, such as via the CSI reporting on PUSCH.

The symbol(s) (e.g., the Z_{ref} and/or Z′_{ref}) and/or the distance (e.g., Z and/or Z′ distance) may be preconfigured/preset/predetermined based on a standard or specification, such as indicated/provided by the BS 102 to the UE 104. In further example, the UE 104 can provide the CSI report in response to multiple or a combination of conditions/parameters/criteria being satisfied/met (e.g., the first uplink symbol to carry the corresponding CSI report(s) starts no earlier than at symbol Z_{ref} and the first uplink symbol to carry the n-th CSI report starts no earlier than at symbol Z′_{ref}(n), including the effect of the timing advance).

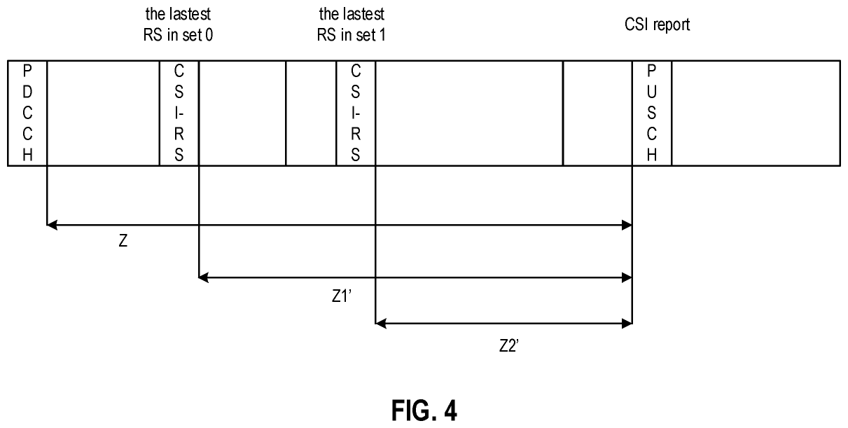

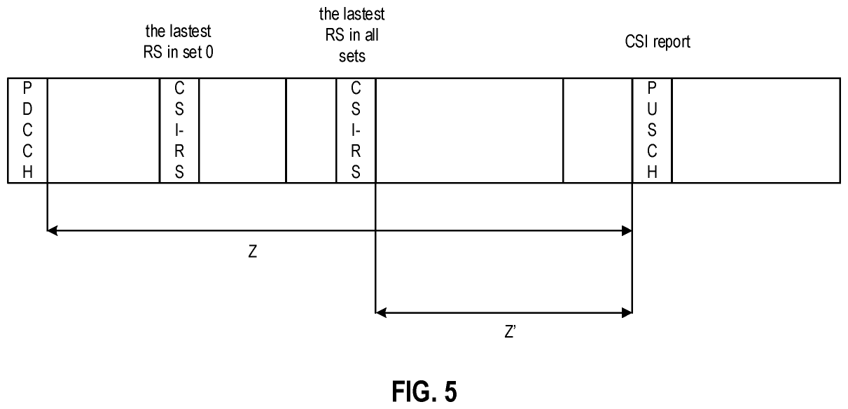

As shown in FIG. 3, the CSI report triggered by the PDCCH can be reported responsive to satisfying/meeting the requirements of Z_{ref} and Z′_{ref}, such as based on the standards or pre-configuration from the BS 102. For instance, the distance Z between the last symbol of the PDCCH and the first symbol of the PUSCH carrying the CSI report may be greater than Z_{ref}, and the distance Z′ between the last symbol of the last CSI resource (e.g., shown as CSI-IM in FIG. 3) to the first symbol of the PUSCH carrying the CSI report is greater than Z′_{ref}. The specification or standards may be established on the basis that or based on only one resource set being configured (e.g., CSI resource, as in certain systems). As discussed herein, the present disclosure may include, enable, or allow for an increased number of sets to two or more (e.g., at least two CSI resource sets). Hence, the present disclosure and the technical solution discussed herein can provide a clarified or improved specification to support/enable/optimize communication between the UE 104 and multiple TRPs based on multiple CSI resources indicated in the DCI on PDCCH, such as shown in FIGS. 4-5, for example.

### I. Solution 1: Calculate for Each Resource Set

Referring to FIG. 4, depicted is an example of CSI reporting for two channel measurement reference (CMR) resource sets (e.g., sets of resources scheduled/configured for CSI RSes to be used for channel measurement). The UE 104 can verify/confirm/identify conditions/parameters/requirements associated with the last resource in each resource set, to determine whether the CSI reporting interval is met/satisfied. For instance, FIG. 4 illustrates two CMR resource sets (e.g., labeled as set 0 and set 1) configuration. In this example, the different sets may include or correspond to different intervals, such as Z1′_{ref} (e.g., second reference) for resource set 0, and Z2′_{ref} (e.g., third reference) for resource set 1. The UE 104 may report the CSI measurement result via CSI reporting on PUSCH when satisfying at least one or a combination of conditions. For instance, the UE 104 may report the CSI measurement results in response to determining that three conditions are met.

The first condition can include a first uplink symbol to carry the corresponding CSI report(s), including the effect of the timing advance, starting no earlier than at symbol Z_{ref}. In this case, the distance Z between the last symbol of the PDCCH and the first symbol of the PUSCH carrying the CSI report can be greater than or equal to Z_{ref} (e.g., the first reference). The second condition can include the first uplink symbol to carry the corresponding CSI report(s), including the effect of the timing advance, starting no earlier than at symbol Z1′_{ref}. In this case, the distance Z1′ between the last symbol of the last CSI resource in the resource set 0 (e.g., CMR resource set 0) and the first symbol of the PUSCH carrying the CSI report can be greater than or equal to Z1′_{ref}. The third condition can include the first uplink symbol to carry the corresponding CSI report(s), including the effect of the timing advance, starting no earlier than at symbol Z2′_{ref}. In this case, the distance Z2′ between the last symbol of the last CSI resource in the resource set 1 (e.g., CMR resource set 1) and the first symbol of the PUSCH carrying the CSI report can be greater than or equal to Z2′_{ref}. In some embodiments, one or more of the conditions discussed in this disclosure can be satisfied when a corresponding distance is greater than or equal to the corresponding reference (e.g., Z_{ref}, Z1′_{ref}, Z2′_{ref}, etc.).

The UE 104 can identify/determine/verify whether one or more other conditions are satisfied, based on the number of CMR resource sets provided/indicated by the DCI. The number of conditions can be based on the number of CMR resource sets (e.g., number of resource sets plus 1, such as including or accounting for the first condition associated with PDCCH). For instance, with a third resource set (e.g., resource set 2) (not shown), the UE 104 can determine whether a fourth condition includes a first uplink symbol, including the timing advance effect, starting earlier than at symbol Z3′_{ref} (not shown), etc. In which case, the distance Z3′ (not shown) between the last (e.g., last/latest in time domain) symbol of the last (e.g., last/latest in time domain, or last/largest in CSI resource index value) CSI resource in the resource set 2 and the first symbol of the PUSCH carrying the CSI report can be greater than Z3′_{ref}, for example.

In the example of FIG. 4, the UE 104 can report the CSI measurement result in response to the three conditions being satisfied. In some cases, the UE 104 may identify at least one condition that is not met or not satisfied. Based on the unsatisfied condition, the UE 104 may provide/send/transmit a different response(s) (or a lack of response) to the BS 102. For example, if the first condition is not satisfied (e.g., distance Z is less than Z_{ref}), the UE 104 may ignore the scheduling DCI (e.g., not report the measurement results), if no HARQ-ACK or transport block is multiplexed on the PUSCH, for example.

In another example, if the first condition is satisfied and at least one of the second condition and/or third condition is not satisfied, the UE 104 may ignore the scheduling DCI (e.g., not report), if no HARQ-ACK or transport block is multiplexed on the PUSCH. In some cases, if the first condition is satisfied and one of the second condition or third condition is not satisfied, the UE 104 may report measurement results of only the resources in the set meeting the corresponding condition's interval requirement/condition (e.g., fall back to single-TRP). For example, if Z1′>Z1′_{ref}, Z2′Z2′_{ref}, the UE 104 can report the measurement result of the resource set 0 (e.g., not report for resource set 1), and if Z1′<Z1′_{ref}, Z2′>Z2′_{ref}, the UE 104 can report the measurement result of the resource set 1 (e.g., not report for resource set 0). Hence, responsive to satisfying one or more conditions, the UE 104 can report/provide/transmit/send the measurement results (e.g., in CSI report) of one or more CMR resource sets to the BS 102 on PUSCH.

### II. Solution 2: Calculate for all Resource Sets

Referring to FIG. 5, depicted is another example of CSI reporting for two CMR resource sets. The UE 104 can verify/identify the last resource in all sets (e.g., in the last resource set) to determine whether the reporting interval is met. For example, one resource setting by the DCI can include various sets of resources, such as two CMR resource sets configuration shown in FIG. 5. In this example, all sets may correspond to the same interval, such as, Z′_{ref} for all resource sets. Hence, the UE 104 can report the measurement result or perform CSI reporting in response to satisfying two conditions.

For example, the first condition to satisfy can include the first uplink symbol to carry the corresponding CSI report(s), including the effect of the timing advance, starting no earlier than at symbol Z_{ref}. In this case, the distance Z between the last symbol of the PDCCH and the first (e.g., first/earliest in time domain) symbol of the PUSCH carrying the CSI report can be greater than or equal to Z_{ref}. The second condition can include the first uplink symbol to carry the corresponding CSI report(s), including the effect of the timing advance, starting no earlier than at symbol Z′_{ref}. In this case, the distance Z′ between the last symbol of the last CSI resource (e.g., last/latest CSI resource in time domain) in all resource sets and the first symbol of the PUSCH carrying the CSI report can be greater than or equal to Z′_{ref}. In this example, the resource sets can include CMR resource set 0 and CMR resource set 1, and the last CSI resource (e.g., the last CSI-RS resource in the time domain of all resource sets) can correspond to or be associated with the resource set 1.

In some implementations, the UE 104 may determine that one or more conditions are not met. Responsive to the determination that at least one condition is not met (e.g., to calculate for all resource sets), the UE 104 may ignore the scheduling DCI (e.g., not report the measurement result of the one or more resource sets) if no HARQ-ACK and/or transport block is multiplexed on the PUSCH.

The values of Z_{ref} and/or Z_{ref}′ may be provided/indicated/obtained from a standard or specification. The BS 102 can provide the values to the UE 104 via the RRC. In some implementations, the values of Z_{ref} and/or Z_{ref}′ can include or correspond to one or more original values (e.g., reuse the original values) as provided in the standards or specification. For instance, the Z_{ref} and/or Z_{ref}′ can include at least one of the values indicated in certain defined tables, for example, Tables 1 or Table 2 (e.g., which can set/define certain CSI computation delay requirement(s)).

TABLE 1

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 2

| | | |
|---|---|---|
| Z₁ [symbols] | Z₂ [symbols] | Z₃ [symbols] |

| μ | Z₁ | Z′₁ | Z₂ | Z′₂ | Z₃ | Z′₃ |
|---|---|---|---|---|---|---|
| 0 | 22 | 16 | 40 | 37 | 22 | X₀ |
| 1 | 33 | 30 | 72 | 69 | 33 | X₁ |
| 2 | 44 | 42 | 141 | 140 | min(44, | X₂ |
| | | | | | X₂ + KB₁) | |
| 3 | 97 | 85 | 152 | 140 | min(97, | X₃ |
| | | | | | X₃ + KB₂) | |

In some cases, the values of Z_{ref} and/or Z′_{ref} can include or correspond to at least one original interval/value plus a delta (e.g., a sum of the original value and the delta/variable/value). For example, with the UE 104 measuring (or configured to measure) the resources in multiple sets during group-based reporting, the original interval may not meet the current processing time of the UE 104 or between the BS 102 and the UE 104 (e.g., due to the lower performance or processing power of the UE 104, communication latency, among other factors). Hence, a delta (e.g., value/variable, adjustment, or added time) may be added/included/incorporated/introduced to the original value, such that the required interval can be expanded to “original value”+delta and the processing time of UEs 104 can be further satisfied. In this example, the delta can be based on one or more factors including at least the capability of the UE 104 (e.g., provided by the UE 104 to the BS 102), the location of the UE 104 (e.g., in relation to the BS 102), the signal quality between the BS 102 and the UE 104, among others. In some cases, the delta may be different for individual subcarrier spacings (SCSs). In some cases, the delta may be the same for multiple SCSs or all of the SCSs. In some cases, the delta may be the same for different conditions, such as the first condition, the second condition, and/or the third condition). In some cases, the delta may be different for the individual conditions, such as different for the first, second, and/or third conditions.

In some implementations, the BS 102 can establish/define/obtain/receive values for a new table (e.g., introduced for MTRP) for the values of Z_{ref} and Z′_{ref}. The new table may include standard/default values that are predefined/preconfigured for the BS 102. A certain parameter (e.g, RRC parameter) may be set to indicate whether the BS 102 and/or the UE 104 should use values from a defined table, or values from such a new table. For example, the BS 102 and/or the UE 104 can use the new table (e.g., the values of the new table) when the RRC parameter is configured for MTRP measurement (e.g., groupBasedBeamReporting-r17 or a new parameter) or a downlink control information (DCI) signaling indicates to use the new table. By using the new table, the processing time of the UE 104 may be extended (e.g., compared to the original values), thereby accounting for the capabilities of the UE 104 and/or communication between the BS 102 and UE 104. In some cases, the new table may be an updated version of the original table, including at least one similar value and/or at least one different value from the original table.

### B. Implementation 2: Application Time of Beam Indication

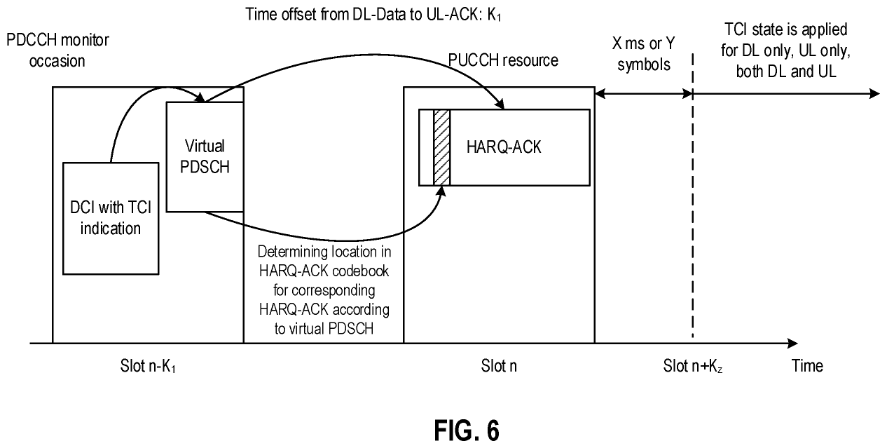

Referring to FIG. 6, depicted is an example of application time of beam indication. In unified TCI state indication, the application time of the DCI-based beam indication (e.g., the application time of the TCI state) can be, include, or correspond to the first slot. The first slot may be at least Y symbols after/subsequent to the last symbol of the acknowledgment (e.g., HARQ-ACK) of the joint or separate DL/UL beam indication. The application time (sometimes referred to as beam application time) can represent a time (e.g., an earliest possible time instance) at which beam/TCI information indicated via DCI signaling, can be accepted, processed, applied and/or implemented by the wireless communication device (e.g., due to its capability). The Y can represent a candidate offset (or adjustment/delta) value for the application time to apply the TCI state, for example. The first slot and the Y symbols can be determined on the carrier (e.g., component carrier (CC)). The SCS (e.g., the smallest SCS, among other carrier(s)) can apply/provide/utilize/implement the beam indication. RRC signaling (e.g., that conveys RRC parameter(s)) can be used to configure the Y value. Based on the position of the Y value, different UE calculation or measurement results (e.g., measurement of the CSI resource(s)) may be outputted/produced/introduced/presented. Hence, the systems and methods of the technical solution discussed herein can clarify/provide/enable configuration method(s) for Y to reduce, avoid, or mitigate the variability of or change in the measurement results. Although Y is sometimes referenced herein in terms of the number of symbols by way of illustration, it should be understood that Y can be expressed in terms of other types of time units (e.g., ms).

### I. Solution 1: Y Configured Per ((Group

In some implementations, Y (e.g., candidate offset value) may be configured per CC group, such as in the RRC parameter: CellGroupConfig. Each CC can include/have a respective SCS. In this case, all CCs in the CC group may have/associated with the same value of Y (e.g., same interval). The UE 104 can determine/calculate the beam application time (e.g., a time for applying the TCI state). For example, the UE 104 can identify a CC with the smallest SCS amongst the CCs applying the beam indication and the group having the CC. The UE 104 can determine an offset value associated with or corresponding to the group that the CC belongs to.

Responsive to determining the offset value, the UE 104 can determine the application time using the offset value, the smallest SCS, and a reference SCS. In this example, the UE 104 can determine/compute/obtain the application time based on beam application time=(smallest SCS/reference SCS)*Y. The reference SCS may be configured by the BS 102, such as based on a standard/default/predefined configuration or specification, or configured/indicated via signaling from the BS 102 (e.g., RRC, MAC CE and/or DCI signaling), among other configuration methods. The BS 102 can provide an indication of the reference SCS to the UE 104. For instance, the BS 102 may configure the reference SCS to 15 kHz, among other frequency values.

### II. Solution 2: Y Configured Per ((List

In some implementations, Y may be configured per CC list via the RRC parameter (e.g., sCellToAddModList), such as one Y for a respective CC list (e.g., list of CCs). One or more CC lists may be included in a CC group. A CC group may be configured with two CC lists, where each CC list includes a respective value of Y (e.g., offset value). In this case, the UE 104 can identify/determine/find/look for the CC with the smallest/lowest SCS among the CCs applying the beam indication. The UE 104 can identify the CC list having the CC with the smallest SCS. Responsive to the identification (e.g., of the CC and the CC list), the UE 104 can determine/calculate/compute the beam application time (BAT) based on or according to the Y value (e.g., offset value) associated with the CC list. Hence, the UE 104 can use the determined Y value (e.g., and/or the smallest SCS and/or a reference SCS) to determine a time=(smallest SCS/reference SCS)*Y for applying the TCI state.

### III. Solution 3: Y Configured Per CC/BWP

In some implementations, Y may be configured per CC/bandwidth part (BWP) (e.g., in a RRC parameter). In this case, each CC may include or be associated with a respective value of Y. For instance, with multiple CCs in a list or group, multiple Y values can be assigned or configured for the multiple CCs. The Y values may be different for individual CCs. In some cases, one or more CCs may be configured/associated with the same Y value.

In this example, the UE 104 may identify a CC with the smallest SCS. The UE 104 can identify the CC or BWP corresponding to the smallest SCS. Responsive to the identification, the UE 104 can determine the BAT based on the Y value associated with the CC/BWP. For instance, the UE 104 can use at least one of the Y value, the smallest SCS, and/or a reference SCS to determine the BAT.

In some cases, different CCs may correspond to or be configured/associated with the same SCS. For instance, if the different CCs correspond to the same SCS, the CCs may be configured with the same Y value. In some other cases, if the different CCs correspond to different SCSs, the CCs may be configured with different Y values, for example.

In some implementations, for inter-cell beam management and/or Multi-Panel UE, the BS 102 and/or the UE 104 can adjust/improve/optimize BAT due to further complexity of beam application. For instance, a new Y′ value may be introduced/configured and/or determined by the BS 102 for inter-cell beam management and/or multi-panel UE (e.g., two value (Y and Y′) can be configured per CC group/CC list/CC/BWP). The new Y′ value can be different from the configuration of Y discussed above, such as the Y configurations of solutions 1-3. In this case, the BS 102 can indicate to the UE 104 to use the Y or new Y′ value for applying the TCI state via the DCI.

In another example, the UE 104 may reuse or continue utilizing the configuration of Y discussed above, such as the Y configurations of solutions 1-3. In this example, the UE 104 (or the BS 102) can apply/consider/incorporate/add an offset value (e.g., delta or variable) to at least one existing Y value. In this case, the BS 102 can indicate to the UE 104 whether to use the offset value on Y value for applying the TCI state via the DCI. For instance, if the BS 102 indicates the UE 104 to use the offset value, the UE 104 can use Y+offset value for applying the TCI state. The offset (e.g., adjustment value) of the Y value can be based on at least the capability of the UE 104 (e.g., performance, network interface card, location, etc.). In some cases, the offset can be based on the connection between the BS 102 and the UE 104 (e.g., traffic handled by the BS 102, the network connection between the BS 102 and UE 104, latency, etc.). Accordingly, the UE 104 can utilize different configurations of Y (e.g., Y value with offset or a new Y value) to determine an application time for applying the TCI state, among other features or operations discussed herein.

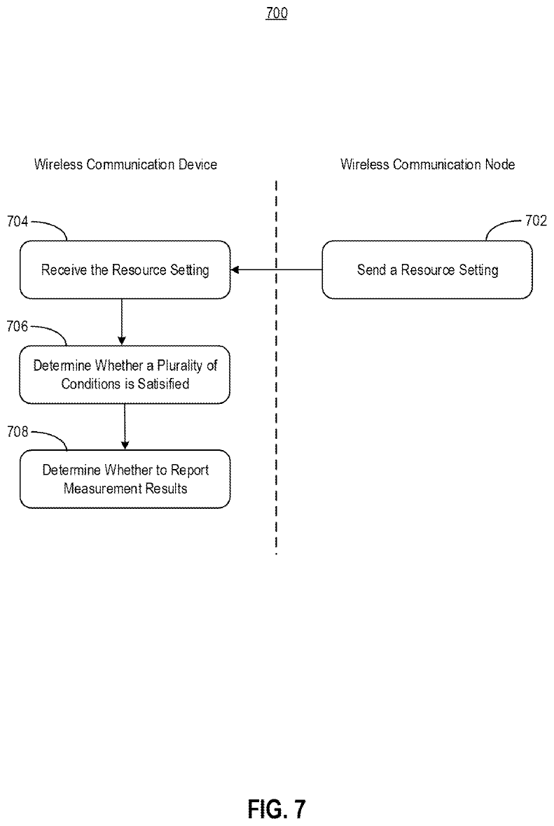

FIG. 7 illustrates a flow diagram of a method 700 for CSI reporting. The method 700 can be implemented using any of the components and devices detailed herein in conjunction with FIGS. 1-6. In overview, the method 700 can include sending a resource setting (702). The method 700 can include receiving the resource setting (704). The method 700 can include determining whether a plurality of conditions is satisfied (706). The method 700 can include determining whether to report measurement results (708).

Referring now to operation (702), a wireless communication node (e.g., a gNB) may send/transmit/provide a resource setting (e.g., a resource configuration) to a wireless communication device (e.g., a UE). The resource setting can be indicative of various sets of channel measurement reference signal (RS) resources (CMRs). Responsive to or subsequent to sending the resource setting, the wireless communication node can cause the wireless communication device to perform/execute/initiate one or more operations/instructions/tasks discussed herein, such as to determine whether to respond to the wireless communication node with measurement results of the one or more resource sets.

At operation (704), the wireless communication device can receive the resource setting indicative of the various sets of CMRs from the wireless communication node. Each set of the various sets of CMRs can include one or more resources (e.g., that can be occupied by CSI RSes to be received and/or measured). In some implementations, a last resource, such as in each set of CMR, can be associated with a respective condition among various conditions.

At operation (706), the wireless communication device can determine whether one or more conditions associated with the sets of CMRs is or are satisfied/met. The wireless communication device can perform the determination responsive to receiving the resource setting. For example, the wireless communication device can consider/identify/analyze a predefined number of (e.g., three) conditions to determine whether one or more of the conditions are met/satisfied. For example, the various conditions may include more than three conditions based on the number of sets of CMRs (e.g., four conditions for three CMR sets, five conditions for four CMR sets, etc.).

In this example, the first condition may include or indicate that a first distance (Z) between a last symbol of a physical downlink control channel (PDCCH) carrying the DCI signaling, and a first symbol of a physical uplink shared channel (PUSCH) (e.g., the first uplink symbol) carrying a measurement result (e.g., CSI report), is greater than or equal to a first reference (Z_{ref}). The second condition may indicate that a second distance (Z1′) between a last symbol of a last CSI resource in a first set of the plurality of sets, and the first symbol of the PUSCH, is greater than or equal to a second reference (Z1′_{ref}). The third condition may indicate that a third distance (Z2′) between a last symbol of a last CSI resource in a second set of the plurality of sets, and the first symbol of the PUSCH, is greater than or equal to a third reference (Z2′_{ref}). The one or more conditions may account for or include an effect of timing advance.

In some implementations, the first reference, the second reference, and/or the third reference may each include a respective adjustment (e.g., offset) added to a respective defined value. The defined values may be indicated in the resource setting, standard, and/or specification, such as indicated by the wireless communication node to the wireless communication device. In some cases, the respective adjustment may be different between the respective defined values. In some other cases, the respective adjustment may be the same across the respective defined values.

In some implementations, whether the first reference, the second reference, and/or the third reference take on/include/correspond to a first set of values or a second set of values (e.g., indicated in/provided in/obtained from the original table or a new table of values), may be indicated by a radio resource control (RRC) parameter (e.g., groupBasedBeamReporting-r17 or a new parameter) or a downlink control information (DCI) signaling.

In some implementations, a last resource, in all sets of CMRs, may be associated with a condition of the various conditions. For example, the various conditions may include or consist of two conditions (e.g., a first condition and a second condition). In this example, the first condition can include or indicate that a first distance (Z) between a last symbol of a PDCCH carrying the DCI signaling, and a first symbol of a PUSCH carrying a measurement result, is greater than or equal to a first reference (Z_{ref.}). The second condition can indicate that a second condition that a second distance (Z′) between a last symbol of a last CSI resource of the plurality of sets, and the first symbol of the PUSCH, is greater than or equal to a second reference (Z′_{ref}).

Further in this example, the respective adjustment may be based on a capability of the wireless communication device (e.g., performance, hardware and/or software support or compatibility, etc.). In some cases, the respective adjustment may be different for different subcarrier spacings (SCSs). In some other cases, the respective adjustment may be the same across the different SCSs.

At operation (708), the wireless communication device can determine whether to report measurement results. In some cases, the wireless communication device may determine that all conditions are satisfied. Responsive to this determination, the wireless communication device can determine to report the measurement results corresponding to the sets of CMRs to the wireless communication node.

In some implementations, the wireless communication device may determine that one or more conditions of the various conditions may not be satisfied. For instance, the wireless communication device may determine that the first condition (e.g., out of the three conditions or two conditions, discussed in the previous examples) is not satisfied. In this case, the wireless communication device may determine to ignore the DCI signaling's scheduling of reporting of one or more measurement results. Hence, the wireless communication device may not report the measurement results in this example.

In some cases, when analyzing the three conditions (or more than three conditions based on the number of sets of CMRs, as discussed in the previous example), the wireless communication device may determine that the first condition is satisfied and at least one of the second condition or the third condition is not satisfied. In this case, responsive to the determination of the satisfied first condition and unsatisfied second and/or third condition, the wireless communication device may determine to at least one of ignoring (e.g., not implementing/acting on) the DCI signaling's scheduling of reporting of the one or more measurement results or reporting a measurement result of a set (e.g., one set) of the various sets of CMRs, corresponding to at least one of the conditions that is satisfied.

In some cases, when analyzing the two conditions (e.g., comparison of Z to Z_{ref} and Z′ to Z′_{ref}), the wireless communication device may determine/identify that at least one of the first condition and/or the second condition is not satisfied. Accordingly, responsive to determining that at least one of the conditions in the two conditions scenario is not satisfied, the wireless communication device may ignore the DCI signaling's scheduling of reporting of the measurement result(s). Hence, the wireless communication device can determine, subsequent to receiving the resource setting from the wireless communication node, whether to report the measurement results based on one or more conditions being satisfied/met or not satisfied.

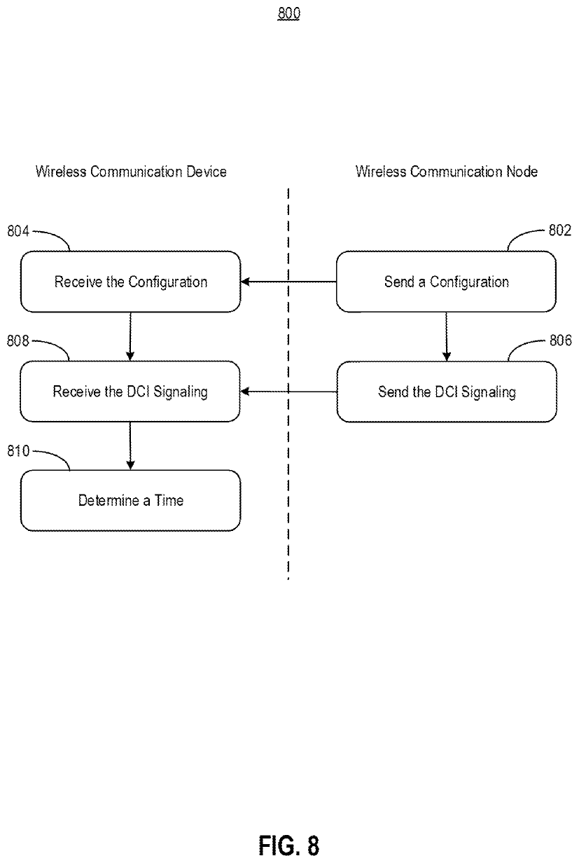

FIG. 8 illustrates a flow diagram of a method 800 for an application time of beam indication. The method 800 can be implemented using any of the components and devices detailed herein in conjunction with FIGS. 1-6. In overview, the method 800 can include sending a configuration (802). The method 800 can include receiving the configuration (804). The method 800 can include sending the DCI signaling (806). The method 800 can include receiving the DCI signaling (808). The method 800 can include determining a time (810).

At operation (802), the wireless communication node (e.g., BS or gNB) can send a configuration to the wireless communication device (e.g., UE). The configuration can include or be of various candidate offset values (e.g., Y symbols) to apply relative to a last symbol of an acknowledgment (e.g., HARQ-ACK) to a downlink control information (DCI) signaling. At operation (804), the wireless communication device can receive the configuration of various candidate offset values relative to the last (e.g., final or latest) symbol of the acknowledgment to a downlink control information (DCI) signaling from the wireless communication node. The offset values may represent/refer to/correspond to the interval from the acknowledgment to the beam application time (BAT). The wireless communication device can use/apply the offset values in the calculation/determination of the time for applying the TCI state.

In some cases, the offset value is determined from various offset values each configured via a respective radio resource control (RRC) parameter for a respective group of component carriers (CCs). Each group of CCs can include one or more lists of CCs. In some other cases, the offset value is determined from various offset values each configured via a respective RRC parameter for a respective list of CCs. The list of CCs may be included in a group of CCs, such as along with one or more other lists of CCs.

In certain cases, the offset value is determined from various offset values may each be configured for a respective CC or bandwidth part (BWP). The CC/BWP may be included in a list or group of CCs. In this case, the CCs including/having the same SCS may be configured with the same offset value. In some implementations, the wireless communication device may receive a configuration of a first offset value and a second offset value from the wireless communication node. The wireless communication device can receive the DCI signaling, which indicates to use at least one of: the first offset value or the second offset value from the wireless communication node. In some cases, the second offset value may include or correspond to an adjustment value.

At operation (806), the wireless communication node can send/transmit/provide the DCI signaling, to indicate a transmission configuration indicator (TCI) state to the wireless communication device. By sending the DCI signaling, the wireless communication node can cause the wireless communication device to perform one or more operations discussed herein, such as determining a time for applying a TCI state, for example.

At operation (808), the wireless communication device can receive the DCI signaling, which indicates the TCI state from the wireless communication node. In some implementations, the wireless communication device can receive the DCI signaling with or without the configuration from the wireless communication node. At operation (810), the wireless communication device can determine a time (e.g., BAT) for applying the TCI state in one or more CCs. The wireless communication device can perform the determination responsive to receiving the DCI signaling. The time for applying the TCI state can be according to or based on an offset value relative to a last symbol of an acknowledgment (e.g., HARQ-ACK) to the DCI signaling. The TCI state may be applied to all CCs or a subset of the CCs, such as the CCs included in the list or group of CCs.

In some implementations, the wireless communication device can determine the time for applying the TCI state, for example by using the offset value, a smallest SCS, and a reference SCS. The offset value may correspond to a group or list comprising a first CC. For example, the wireless communication device can identify a first CC as a CC with the smallest SCS amongst various CCs (e.g., one or more CCs), such as within a group or list of CCs. The wireless communication device can identify a first group or a first list of the CCs having the first CC (e.g., the group or list corresponding to the smallest SCS). Responsive to identifying the first group or the first list, the wireless communication device may determine the offset value corresponding to the identified first group or the first list of CCs. The Y (e.g., offset value) can be specified in an RRC parameter corresponding to the first CC group of list. For instance, each group or list may include/have a corresponding RRC parameter.

Responsive to determining the offset value, the wireless communication device can determine the time for applying the TCI state, using the determined offset value, the smallest SCS, and a reference SCS. The wireless communication device can apply the TCI state for one or more CCs, such as the first CC, all CCs within the group or list, or a subset of CCs within the group or list, for example. In some implementations, the wireless communication device can receive an indication of the reference SCS from the wireless communication node. For instance, the indication of the reference SCS may be provided in the configuration from the wireless communication node, among other information on PDCCH. In some cases, all CCs (or a subset of CCs) in the first group or the first list of CCs may include/have/share the same value for the offset value.

In some implementations, the wireless communication device can determine the time for applying the TCI state, using the offset value, a smallest SCS, and a reference SCS, where the offset value corresponds to a first CC. The wireless communication device can identify the first CC as a CC with a smallest subcarrier spacing (SCS) amongst the CCs (e.g., one or more CCs).

In some implementations, the wireless communication device can determine the time for applying the TCI state, by adding/including/enforcing/incorporating an adjustment value (e.g., offset for adding to Y) to the determined offset value (e.g., Y). In this case, the wireless communication device can add the adjustment value, such as in the scenerios for inter-cell management and/or the wireless communication device having multiple panels. The adjustment value may be based on the capability of the wireless communication device, such as the hardware and/or software performance of the wireless communication device. In some cases, the adjustment value may be based on the connection quality/condition between the wireless communication device and the wireless communication node, such as latency, communication quality, among other factors or conditions.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a downlink control information (DCI) signaling, which indicates a transmission configuration indicator (TCI) state; and
determining, by the wireless communication device, a time for applying the TCI state in one or more component carriers (CCs), according to an offset value relative to a last symbol of an acknowledgment to the DCI signaling.

2. The method of claim 1, further comprising:
identifying, by the wireless communication device, a CC with a smallest subcarrier spacing (SCS) amongst one or more CCs.

3. The method of claim 1, wherein the offset value is determined from a plurality of offset values each configured for a respective component carrier (CC) or bandwidth part (BWP).

4. The method of claim 3, further comprising:
determining, by the wireless communication device, the time for applying the TCI state, using the offset value, a smallest SCS and a reference SCS, wherein the offset value corresponds to a first CC.

5. The method of claim 4, further comprising:
identifying, by the wireless communication device, a CC with a smallest subcarrier spacing (SCS) amongst of one or more CCs.

6. The method of claim 3, wherein CCs having a same subcarrier spacing (SCS) is configured with a same offset value.

7. The method of claim 1, comprising:
receiving, by the wireless communication device from a wireless communication node, a configuration of a first offset value and a second offset value; and
receiving, by the wireless communication device from the wireless communication node, the DCI signaling, which indicates to use at least one of: the first offset value or the second offset value.

8. A wireless communication device, comprising:
at least one processor configured to:
receive, via a receiver a from a wireless communication node, a downlink control information (DCI) signaling, which indicates a transmission configuration indicator (TCI) state; and
determine a time for applying the TCI state in one or more component carriers (CCs), according to an offset value relative to a last symbol of an acknowledgment to the DCI signaling.

9. The wireless communication device of claim 8, wherein the at least one processor is further configured to:
identify a CC with a smallest subcarrier spacing (SCS) amongst one or more CCs.

10. The wireless communication device of claim 8, wherein the offset value is determined from a plurality of offset values each configured for a respective component carrier (CC) or bandwidth part (BWP).

11. The wireless communication device of claim 10, wherein the at least one processor is further configured to:
determine the time for applying the TCI state, using the offset value, a smallest SCS and a reference SCS, wherein the offset value corresponds to a first CC.

12. The wireless communication device of claim 11, wherein the at least one processor is further configured to:
identify a CC with a smallest subcarrier spacing (SCS) amongst of one or more CCs.

13. The wireless communication device of claim 10, wherein CCs having a same subcarrier spacing (SCS) is configured with a same offset value.

14. The wireless communication device of claim 8, wherein the at least one processor is configured to:
receive, via a receiver from a wireless communication node, a configuration of a first offset value and a second offset value; and
receive, via the receiver from the wireless communication node, the DCI signaling, which indicates to use at least one of: the first offset value or the second offset value.

15. A method comprising:
sending, by a wireless communication node to a wireless communication device, a downlink control information (DCI) signaling, which indicates a transmission configuration indicator (TCI) state,
wherein a time for applying the TCI state in one or more component carriers (CCs), is determined according to an offset value relative to a last symbol of an acknowledgment to the DCI signaling.

16. A wireless communication node, comprising:
at least one processor configured to:
send, via a transmitter to a wireless communication device, a downlink control information (DCI) signaling, which indicates a transmission configuration indicator (TCI) state,
wherein a time for applying the TCI state in one or more component carriers (CCs), is determined according to an offset value relative to a last symbol of an acknowledgment to the DCI signaling.

17. The wireless communication node of claim 16, wherein the wireless communication device identifies a CC with a smallest subcarrier spacing (SCS) amongst one or more CCs.

18. The wireless communication node of claim 16, wherein the offset value is determined from a plurality of offset values each configured for a respective component carrier (CC) or bandwidth part (BWP).

19. The wireless communication node of claim 18, wherein the wireless communication device determines the time for applying the TCI state, using the offset value, a smallest SCS and a reference SCS, wherein the offset value corresponds to a first CC.

20. The wireless communication device of claim 19, wherein the wireless communication device identifies a CC with a smallest subcarrier spacing (SCS) amongst of one or more CCs.
